(19) United States
(12) Patent Application Publication
(10) Pub. No.: US 2020/0117368 A1
(43) Pub. Date: Apr. 16, 2020

(54) METHOD FOR ACHIEVING DATA COPYING IN FTL OF SOLID STATE DRIVE, SYSTEM AND SOLID STATE DRIVE

(71) Applicant: SHENZHEN DAPU MICROELECTRONICS CO., LTD., Shenzhen (CN)

(72) Inventors: Song Jiang, Shenzhen (CN); Qing Yang, Shenzhen (CN)

(73) Assignee: SHENZHEN DAPU MICROELECTRONICS CO., LTD., Shenzhen (CN)

(21) Appl. No.: 16/711,418

(22) Filed: Dec. 11, 2019

Related U.S. Application Data
(63) Continuation of application No. PCT/CN2018/094548, filed on Jul. 4, 2018.

(30) Foreign Application Priority Data
Jul. 19, 2017 (CN) 201710591084.4

(51) Int. Cl. G06F 3/06; G06F 12/02

(52) U.S. Cl. CPC G06F 3/065; G06F 12/0246; G06F 3/0679; G06F 2212/7211; G06F 2212/7201; G06F 2212/7205; G06F 3/0604

(57) ABSTRACT

The present disclosure discloses method, system and a solid-state drive for data copying in FTL of a solid-state drive, wherein the method comprises the steps of: maintaining an address mapping table for mapping logical addresses to physical addresses in FTL, maintaining an array or a linked list for the physical addresses to be copied to record one or more logical addresses mapping to the physical addresses, maintaining a reverse address mapping table formed by mapping the physical addresses to the logical addresses; receiving a non-duplication copy command that software sent to the solid-state drive; modifying the address mapping and the reverse address mapping in accordance with the non-duplication copy command to complete the non-duplication copy. Through the embodiment of the present disclosure, unnecessary write operations in the SSDs are reduced, and further the copying time is reduced, the service lifespan of SSDs is prolonged, the data reliability is improved.

### CROSS-REFERENCE TO RELATED APPLICATIONS

The present application is a continuation of International Application No. PCT/CN2018/094548, filed on Jul. 4, 2018, which claims priority to Chinese Patent Application No. 201710591084.4, filed on Jul. 19, 2017. The entire contents of both applications are incorporated herein by reference.

### TECHNICAL FIELD

The present disclosure relates to the field of solid-state drive, and more particularly to method, system and solid-state drive for data copying in FTL of a solid-state drive.

### BACKGROUND

The FTL(Flash translation layer) is the design core of the SSD (solid-state Drives). And the FTL of the current SSD doesn't provide implementation for supporting copying command of internal data, and even doesn't provide support for zero data copying. It only directly supports the basic commands of READ, WRITE and TRIM, etc. Accordingly, it only implements the basic functions of addresses mapping, garbage collection, data read, data write and wear leveling, etc.

The current SSDs are incapable of meeting the requirement of data copying largely used by the current applications and system programs. It needs the CPU and memory of the host to participate in the physical copy of the data, including reading from the SSDs and writing to the SSDs. However the prior art has two defects as follows: (1) physical data copy causes excessive time consumption of copy, and waste time of reading/writing bandwidth and CPU of SSDs; (2) after a write operation, a flush command is always sent to the SSD to ensure persistence and consistency of the data. But executing the flush command is time consuming, will reduce SSDs performance, and the write operation of the SSDs will shorten the lifespan of the SSDs.

### SUMMARY OF THE DISCLOSURE

The technical problem to be solved by the present disclosure is providing a method, system and solid-state drive for data copying in FTL to reduce unnecessary write operations in the SSDs, and further to reduce the copying time, prolong the service lifespan of SSDs, and improve the data reliability.

In order to solve the above problems, the present disclosure use the following technical solutions:

In an aspect of the embodiment of the present disclosure, a method for data copying in FTL of a solid-state drive is provided, including:

Maintaining an address mapping table for mapping logical addresses LA to physical addresses in FTL, maintaining an array or a linked list for the physical addresses PAdest to be copied to record one or more logical addresses LAi mapping to the physical addresses PAdest, wherein i=1, 2, 3 . . . N, N [symbol] 1, maintaining a reverse address mapping table formed by mapping the physical addresses PAdest to the logical addresses LAi, wherein N is named as mapping count;

Receiving a non-duplication copy command that software sent to the solid-state drive, the non-duplication copy command comprises a source logical address LAsrc copied, a target logical addresses LAdest and number M of data blocks need to be copied;

Modifying the address mapping table and the reverse address mapping table in accordance with the non-duplication copy command, to point the target logical address LAdest to the physical address that the source logical address LAsrc mapped to, and to complete the non-duplication copy.

Wherein, modifying the address mapping and the reverse address mapping in accordance with the non-duplication copy command to complete the non-duplication copy further comprises:

Looking up the address mapping table by the FTL to determine whether the target logical address LAdest has mapped to one physical address PAdest, if the target logical address LAdest has not mapped to one physical address PAdest, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; if the target logical address LAdest has mapped to one physical address PAdest, the flash page on the physical address PAdest is invalid, looking up the physical address PAsrc corresponding to the source logical address LAsrc in the address mapping table, and the physical address PAsrc is taken as the physical address of the target logical address LAdest, that is writing the (LAdest, PAsrc) into the address mapping table;

Writing (LAdest+1, PAsrc+1), (LAdest+2, PAsrc+2), . . . (LAdest+M−1, PAsrc+M−1) into the address mapping table in accordance with the number M of data blocks need to be copied, to complete the non-duplication copy.

Wherein, receiving the non-duplication copy command that the software sent to the solid-state drive is specifically: receiving the non-duplication copy command that software sent to the solid-state drive by an operation system invoking.

Wherein, after the step of maintaining a reverse address mapping table formed by mapping the physical addresses PAdest to the logical addresses LAi, wherein N is named as mapping count, further comprises:

When the FTL is doing garbage collection and static wear leveling, if the logic address or the physical address involved is in the reverse address mapping table, correspondingly updating the address mapping table and the reverse address mapping table.

In the second aspect of the embodiment of the present disclosure, a system for data copying in FTL of a solid-state drive is provided, including:

A mapping table maintenance unit configured to maintain an address mapping table for mapping logical addresses LA to physical addresses, to maintain an array or a linked list for the physical addresses PAdest to be copied to record one or more logical addresses LAi mapping to the physical addresses PAdest, wherein i=1, 2, 3 . . . N, N [symbol] 1, to maintain a reverse address mapping table formed by mapping the physical addresses PAdest to the logical addresses LAi, wherein N is named as mapping count;

A command receiving unit configured to receive a non-duplication copy command that software sent to the solid-state drive, the non-duplication copy command comprises a source logical address LAsrc copied, a target logical addresses LAdest and number M of data blocks need to be copied;

A modification unit configured to modify the address mapping and the reverse address mapping in accordance with the non-duplication copy command, to point the target logical address LAdest to the physical address that the source logical address LAsrc mapped to, and to complete the non-duplication copy.

Wherein, the modification unit is specifically configured to look up the address mapping table to determine whether the target logical address LAdest has mapped to one physical address PAdest, if the target logical address LAdest has not mapped to one physical address PAdest, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; if the target logical address LAdest has mapped to one physical address PAdest, the flash page on the physical address PAdest is invalid, looking up the physical address PAsrc corresponding to the source logical address LAsrc in the address mapping table, and the physical address PAsrc is taken as the physical address of the target logical address LAdest, that is writing the (LAdest, PAsrc) into the address mapping table;

To write (LAdest+1, PAsrc+1), (LAdest+2, PAsrc+2), (LAdest+M−1, PAsrc+M−1) into the address mapping table in accordance with the number M of data blocks need to be copied, to complete the non-duplication copy.

Wherein, receiving the non-duplication copy command that the software sent to the solid-state drive is specifically: receiving the non-duplication copy command that software sent to the solid-state drive by an operation system invoking.

Wherein, when the FTL is doing garbage collection and static wear leveling, if the logic address or the physical address involved is in the reverse address mapping table, the modification unit is further configured to correspondingly update the address mapping table and the reverse address mapping table.

In the third aspect of the embodiment of the present disclosure, a solid-state drive is provided to execute the following steps:

Maintaining an address mapping table for mapping logical addresses LA to physical addresses in FTL, maintaining an array or a linked list for the physical addresses PAdest to be copied to record one or more logical addresses LAi mapping to the physical addresses PAdest, wherein i=1, 2, 3 . . . N, N [symbol] 1, maintaining a reverse address mapping table formed by mapping the physical addresses PAdest to the logical addresses LAi, wherein N is named as mapping count;

Receiving a non-duplication copy command that software sent to the solid-state drive, the non-duplication copy command comprises a source logical address LAsrc copied, a target logical addresses LAdest and number M of data blocks need to be copied;

Modifying the address mapping and the reverse address mapping in accordance with the non-duplication copy command, to point the target logical address LAdest to the physical address that the source logical address LAsrc mapped to, and to complete the non-duplication copy.

Wherein, modifying the address mapping and the reverse address mapping in accordance with the non-duplication copy command to complete the non-duplication copy further comprises:

Looking up the address mapping table by the FTL to determine whether the target logical address LAdest has mapped to one physical address PAdest, if the target logical address LAdest has not mapped to one physical address PAdest, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; if the target logical address LAdest has mapped to one physical address PAdest, the flash page on the physical address PAdest is invalid, looking up the physical address PAsrc corresponding to the source logical address LAsrc in the address mapping table, and the physical address PAsrc is taken as the physical address of the target logical address LAdest, that is writing the (LAdest, PAsrc) into the address mapping table;

Writing (LAdest+1, PAsrc+1), (LAdest+2, PAsrc+2), (LAdest+M−1, PAsrc+M−1) into the address mapping table in accordance with the number M of data blocks need to be copied, to complete the non-duplication copy.

Comparing with the prior arts, the beneficial effects of the present disclosure are: the present disclosure maintains an address mapping table for mapping logical addresses LA to physical addresses PA in FTL, and a reverse address mapping table formed by mapping the physical addresses PAdest to a plurality of logical addresses LAi. When the SSD needs to copy data, it modifies the address mapping table and the reverse address mapping table in accordance with the source logical address LAsrc copied, the target logical addresses LAdest and the number of data blocks need to be copied in the non-duplication copy command, and to point the target logical address to the physical address that the source logical address mapped to. Such that, accessing to the target logical addresses may get the same data as the source logical address, it needs no physical copy of the data, unnecessary write operations in the SSDs are reduced, and further the copying time is reduced, the service lifespan of SSDs is prolonged, the data reliability is improved.

### BRIEF DESCRIPTION OF THE DRAWINGS

In order to more clearly illustrate the embodiments of the present application or the technical solutions in the prior art, the drawings to be used in the embodiments or the prior art description will be briefly described below. It is apparent that the drawings in the following description are only some of the embodiments described in the present application, and those skilled in the art can obtain other drawings based on these drawings without any creative work.

FIG. 1 is a method flow chart of an embodiment of a method for data copying in FTL of a solid-state drive provided in the detailed description of the present application;

FIG. 2 is a method flow chart of another embodiment of a method for data copying in FTL of a solid-state drive provided in the detailed description of the present application;

FIG. 3 is a structural block diagram of an embodiment of a system for data copying in FTL of a solid-state drive provided in the detailed description of the present application.

### DETAILED DESCRIPTION

The technical solutions in the embodiments of the present disclosure will be clearly and completely described below in conjunction with the accompanying drawings in the embodiments of the present disclosure. It is apparent that the described embodiments are only a part of the embodiments of the present disclosure, and not all of the embodiments. All other embodiments obtained by those skilled in the art based on the embodiments of the present disclosure without creative efforts are within the scope of the present disclosure.

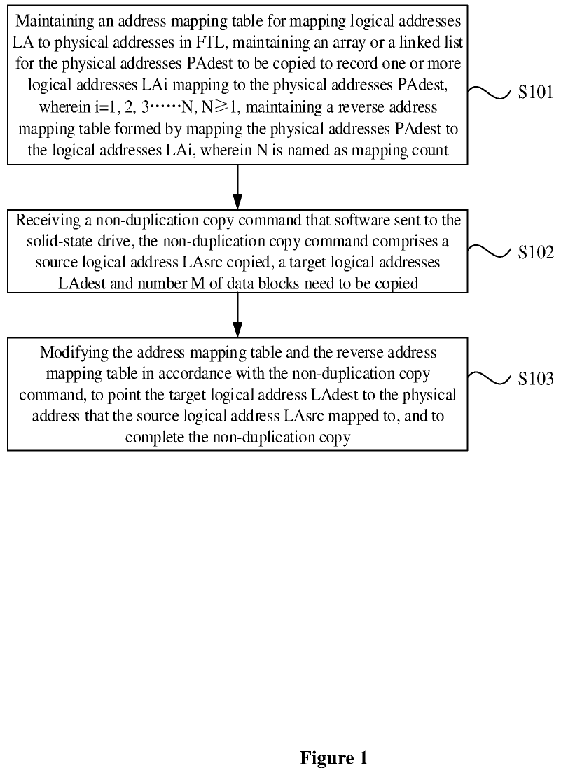

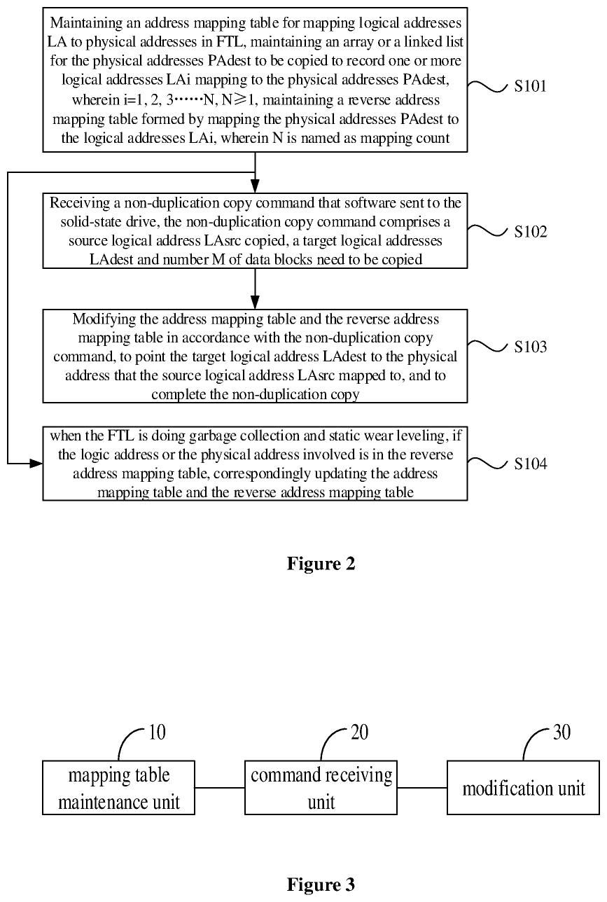

The method for data copying in FTL of a solid-state drive provided in an embodiment of the present application will be clearly and completely described below in conjunction with FIGS. 1-2. Referring to FIG. 1, it is the method flow chart of the first embodiment of the method for data copying in FTL of a solid-state drive provided in the detailed description of the present application. As shown in FIG. 1, in some embodiments, the method including the steps of S101˜S103, details are as follows:

Step S101: maintaining an address mapping table for mapping logical addresses LA to physical addresses PA in FTL, maintaining an array or a linked list for the physical addresses PAdest to be copied to record one or more logical addresses LAi mapping to the physical addresses PAdest, wherein i=1, 2, 3 . . . N,N [symbol] 1 maintaining a reverse address mapping table formed by mapping the physical addresses PAdest to the logical addresses LAi, wherein N is named as mapping count;

Step S102: receiving a non-duplication copy command that software sent to the solid-state drive, the non-duplication copy command comprises a source logical address LAsrc copied, a target logical addresses LAdest and number M of data blocks need to be copied, wherein M is positive integer.

In some embodiments, the software includes the applications in the host and the system software in the operation system. The step of receiving a non-duplication copy command that software sent to the solid-state drive is specifically: receiving the non-duplication copy command that software sent to the solid-state drive by an operation system invoking, and this is for the applications. The applications need to invoke the operation system to send the non-duplication copy command to the FTL.

Step S103: modifying the address mapping table and the reverse address mapping table in accordance with the non-duplication copy command, to point the target logical address LAdest to the physical address that the source logical address LAsrc mapped to, and to complete the non-duplication copy.

In some optimal embodiments, step S103: modifying the address mapping and the reverse address mapping in accordance with the non-duplication copy command to complete the non-duplication copy, includes:

Step S1031: looking up the address mapping table by the FTL to determine whether the target logical address LAdest has mapped to one physical address PAdest, if the target logical address LAdest has not mapped to one physical address PAdest, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; if the target logical address LAdest has mapped to one physical address PAdest, the flash page on the physical address PAdest is invalid (if it is the physical page address, invalidate the flash page on the physical page address, to be illustrated is that the flash does not support direct page modification or deletion. The flash may only mark the page as an useless page, and then erase the useless pages in a larger data unit, the position can be rewritten after erase), looking up the physical address PAsrc corresponding to the source logical address LAsrc in the address mapping table, and the physical address PAsrc is taken as the physical address of the target logical address LAdest, that is writing the (LAdest, PAsrc) into the address mapping table.

The reverse address mapping table cannot be lost due to accidents such as sudden power down, and it needs the limited power of super capacitor or battery to written back immediately after the accidents. In view of that the limited power can only support a small number of data to be written back, and the DRAM capacity in the SSD is limited, the reverse address mapping table needs to be limited within a certain size. Therefore, the following two ways can be used to reduce the size of the reverse address mapping table: (1) periodically write it back to ensure that the size of the dirty pages in the DRAM is within the tolerance scope; (2) periodically delete the table items which mapping count is 1 from the reverse address mapping table. If necessary, respectively write the logical pages related to the physical pages which mapping count N [symbol] 1 to different pages, then reduce their mapping count to 1 and delete them.

Step S1032: writing (LAdest+1, PAsrc+1), (LAdest+2, PAsrc+2), (LAdest+M−1, PAsrc+M−1) into the address mapping table in accordance with the number M of data blocks need to be copied, to complete the non-duplication copy.

FIG. 2 is a method flow chart of another embodiment of a method for data copying in FTL of a solid-state drive provided in the detailed description of the present application. As shown in FIG. 2, as an embodiment, after the step of maintaining a reverse address mapping table formed by mapping from the physical addresses PAdest to the logical addresses LAi, wherein N is named as mapping count, further comprises, the method further includes step S104:

when the FTL is doing garbage collection and static wear leveling, if the logic address or the physical address involved is in the reverse address mapping table, correspondingly updating the address mapping table and the reverse address mapping table. Therefore, when the mapping relationship between the logical address and the physical address is changed, the address mapping table and the reverse address mapping table can be timely updated, to ensure the accuracy when implementing data copy.

As an embodiment, the FTL maintains an address mapping table for mapping logical addresses LBA to physical addresses PBA, the FTL looks up the address mapping table to determine whether the target block address LBAdest has mapped to one physical block address PBAdest, if the target logical block address LBAdest has not mapped to one physical block address PBAdest, looking up the physical address PBAsrc of the source address LBAsrc corresponding to the target block address LABdest in the address mapping table, and the physical address PBAsrc is taken as the physical block address of the target logical block address LBAdest, that is writing the (LBAdest, PBAsrc) into the address mapping table; if the target block address LBAdest has mapped to one physical block address PBAdest, the flash block on the physical address PBAdest is invalid, looking up the physical block address PBAsrc of the source logical address LBAsrc corresponding to the target logical block address LBAdest in the address mapping table, and the physical block address PBAsrc is taken as the physical block address of the source logical block address LBAdest, that is writing the (LBAdest, PBAsrc) into the address mapping table. An array or a linked list is maintained for the physical block addresses PBAdest to be copied, to record one or more logical block addresses LBAi mapping to the physical block addresses PBAdest, wherein i=1, 2, 3 . . . N, N [symbol] 1, a reverse address mapping table is formed by the mapping relationship between the physical addresses PBAdest to a plurality of logical block addresses LBAi, wherein N is named as mapping count; each physical block address PBAdest in the reverse address mapping table maintains a mapping count N.

In the embodiment, the data copied is the same as the target data, the data does not need to be physically copied, and it only needs to modify the mapping relationship related to the address. The detailed method is: point the target logical address to the physical logical address that the source logical address mapped to, in this way, the access to the target logical address will get the same data as the source logical address, which has the effect of copying functionally. To be clear, SSD (read or write) is used in a read/write unit with a certain data size, the unit is generally named as block. The internal management of SSD also reads and writes data from its internal flash memory in a certain data size unit which is generally named as page. The two units may have different size, but it won't influence the design. To facilitate understanding, they can be considered the same size.

In some embodiments, the non-duplication copy command of the zero data copying may be invoked through an operation system to provided to the applications. A wide variety of applications and system programs can use the operation system to invoke or the non-duplication copy command to greatly improve performance, to replace the physical copy of data on the SSD implemented by two steps read and write with a operation invoking of a non-duplication copy or a non-duplication copy command. The non-duplication copy command can be applied to the following application scenarios: 1. log operation in the database or the file system; 2. file write operation in the OverlayFS/UnionFS of the virtual executing environment supporting Container; 3. full defragmenting operation of the SSD; 4. Operation of increasing or reducing blocks in the file; 5. software implementing dereplication of block level. Usage of non-duplication copy can greatly improve the performance of the software, besides improving I/O performance, it reduces unnecessary write operations in the SSDs, and then prolongs the service lifespan of SSDs and improve the data reliability.

As mentioned above, the embodiment maintains an address mapping table for mapping logical addresses LA to physical addresses PA, and a reverse address mapping table formed by the mapping from the physical addresses PAdest to a plurality of logical addresses LAi. When the SSD needs to copy data, it modifies the address mapping table and the reverse address mapping table in accordance with the source logical address LAsrc copied, the target logical addresses LAdest and the number of data blocks need to be copied in the non-duplication copy command, and to point the target logical address to the physical address that the source logical address mapped to. Such that, accessing to the target logical addresses may get the same data as the source logical address, it needs no physical copy of the data, unnecessary write operations in the SSDs are reduced, and further the copying time is reduced, the service lifespan of SSDs is prolonged, the data reliability is improved.

The following is an embodiment of a system for data copying in FTL of a solid-state drive provided in the detailed description of the present application. The embodiment of the system is implemented based on the embodiment of the above method, for the incomplete description of the system, please refer to the embodiment of the above method.

Refer to FIG. 3, it is a structural block diagram of an embodiment of a system for data copying in FTL of a solid-state drive provided in the detailed description of the present application. As shown in FIG. 3, the system includes:

A mapping table maintenance unit 10 configured to maintain an address mapping table for mapping logical addresses LA to physical addresses, to maintain an array or a linked list for the physical addresses PAdest to be copied to record one or more logical addresses LAi mapping to the physical addresses PAdest, wherein i=1, 2, 3 . . . N, N [symbol] 1, to maintain a reverse address mapping table formed by mapping the physical addresses PAdest to the logical addresses LAi, wherein N is named as mapping count;

A command receiving unit 20 configured to receive a non-duplication copy command that software sent to the solid-state drive, the non-duplication copy command comprises a source logical address LAsrc copied, a target logical addresses LAdest and number M of data blocks need to be copied, wherein M is positive integer. In some embodiments, the software includes the applications in the host and the operation system in the system software. The step of receiving a non-duplication copy command that software sent to the solid-state drive is specifically: receiving the non-duplication copy command that software sent to the solid-state drive by an operation system invoking, and this is for the applications. The applications need to invoke the operation system to send the non-duplication copy command to the FTL.

A modification unit 30 configured to modify the address mapping and the reverse address mapping in accordance with the non-duplication copy command, to point the target logical address LAdest to the physical address that the source logical address LAsrc mapped to, and to complete the non-duplication copy.

In some embodiments, the modification unit 30 is specifically configured to look up the address mapping table to determine whether the target logical address LAdest has mapped to one physical address PAdest, if the target logical address LAdest has not mapped to one physical address PAdest, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; if the target logical address LAdest has mapped to one physical address PAdest, the flash page on the physical address PAdest is invalid, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; to write (LAdest+1, PAsrc+1), (LAdest+2, PAsrc+2), . . . (LAdest+M−1, PAsrc+M−1) into the address mapping table in accordance with the number M of data blocks need to be copied, to complete the non-duplication copy.

In some embodiments, the modification unit 30 is further configured to: when the FTL is doing garbage collection and static wear leveling, if the logic address or the physical address involved is in the reverse address mapping table, correspondingly update the address mapping table and the reverse address mapping table.

As mentioned above, the system for data copying in FTL of a solid-state drive provided in the embodiment maintains an address mapping table for mapping logical addresses LA to physical addresses PA, and a reverse address mapping table formed by the mapping from the physical addresses PAdest to a plurality of logical addresses LAi. When the SSD needs to copy data, it modifies the address mapping table and the reverse address mapping table in accordance with the source logical address LAsrc copied, the target logical addresses LAdest and the number of data blocks need to be copied in the non-duplication copy command, and to point the target logical address to the physical address that the source logical address mapped to. Such that, accessing to the target logical addresses may get the same data as the source logical address, it needs no physical copy of the data, unnecessary write operations in the SSDs are reduced, and further the copying time is reduced, the service lifespan of SSDs is prolonged, the data reliability is improved.

The application embodiment also provides a SSD, the FTL of the SSD is configured to execute the steps S101˜S103 of the embodiment of the above method following steps, details are as follows:

Maintaining an address mapping table for mapping logical addresses LA to physical addresses, maintaining an array or a linked list for the physical addresses PAdest to be copied to record one or more logical addresses LAi mapping to the physical addresses PAdest, wherein i=1, 2, 3 N, N [symbol] 1, maintaining a reverse address mapping table formed by mapping the physical addresses PAdest to the logical addresses LAi, wherein N is named as mapping count;

Step S102: receiving a non-duplication copy command that software sent to the solid-state drive, the non-duplication copy command comprises a source logical address LAsrc copied, a target logical addresses LAdest and number M of data blocks need to be copied, wherein M is positive integer;

Step S103: modifying the address mapping and the reverse address mapping in accordance with the non-duplication copy command, to point the target logical address LAdest to the physical address that the source logical address LAsrc mapped to, and to complete the non-duplication copy.

In some optimal embodiments, step S103: modifying the address mapping and the reverse address mapping in accordance with the non-duplication copy command to complete the non-duplication copy, includes steps S1031-S1032, details are as follows:

Step S1031: looking up the address mapping table by the FTL to determine whether the target logical address LAdest has mapped to one physical address PAdest, if the target logical address LAdest has not mapped to one physical address PAdest, looking up the physical address PAsrc corresponding to the source logical address LAsrc in the address mapping table, and the physical address PAsrc is taken as the physical address of the target logical address LAdest, that is writing the (LAdest, PAsrc) into the address mapping table; if the target logical address LAdest has mapped to one physical address PAdest, the flash page on the physical address PAdest is invalid, looking up the physical address PAsrc corresponding to the source logical address LAsrc in the address mapping table, and the physical address PAsrc is taken as the physical address of the target logical address LAdest, that is writing the (LAdest, PAsrc) into the address mapping table.

Step S1032: writing (LAdest+1, PAsrc+1), (LAdest+2, PAsrc+2), . . . ,(LAdest+M−1, PAsrc+M−1) into the address mapping table in accordance with the number M of data blocks need to be copied, to complete the non-duplication copy.

The SSD provided in the embodiment is further configured to execute other steps and content of the embodiment of the above method, for the incomplete description of the system, please refer to the embodiment of the above method.

The SSD provided in the embodiment maintains an address mapping table for mapping logical addresses LA to physical addresses PA, and a reverse address mapping table formed by mapping the physical addresses PAdest to a plurality of logical addresses LAi. When the SSD needs to copy data, it modifies the address mapping table and the reverse address mapping table in accordance with the source logical address LAsrc copied, the target logical addresses LAdest and the number of data blocks need to be copied in the non-duplication copy command, and to point the target logical address to the physical address that the source logical address mapped to. Such that, accessing to the target logical addresses may get the same data as the source logical address, it needs no physical copy of the data, unnecessary write operations in the SSDs are reduced, and further the copying time is reduced, the service lifespan of SSDs is prolonged, the data reliability is improved.

The technical principle of the present application has been described above with reference to embodiments. These descriptions are only for explaining the principle of the present application, and cannot be interpreted in any way as limiting the protection scope of the present application. The content shown by the drawings is only one of the embodiments of the present application, and the actual structure is not limited thereto. Based on the explanation herein, the person skilled in the art may associate other embodiments of the present application without creative effort, and all of these embodiments should be considered to fall into the protection scope of the present application.

What is claimed is:

1. A method for data copying in Flash translation layer (FTL) of a solid-state drive, comprising:
maintaining, in the FTL, (i) an address mapping table for mapping logical addresses to physical addresses, (ii) an array or a linked list for at least one destination physical address of the physical addresses that are to be copied, the array or the linked listing recording one or more logical addresses of the logical addresses mapping to the at least one destination physical address, and (iii) a reverse address mapping table for mapping the at least one destination physical address to the one or more logical addresses;
receiving a non-duplication copy command by the solid-state drive comprising a source logical address, a destination logical address, and a number of data blocks to be copied;
determining a source physical address to which the source logical address maps based on the address mapping table; and
performing the non-duplication copy command by modifying the address mapping table and the reverse address mapping table to map the destination logical address to the source physical address.

2. The method of claim 1, wherein modifying the address mapping table and the reverse address mapping table comprises:
looking up the address mapping table in the FTL to determine whether the destination logical address has mapped to one of the destination physical address;
in response to the destination logical address has not mapped to a physical address, setting the source physical address as the destination physical address; and
in response to the destination logical address has mapped to a physical address, invalidating a Flash memory page on which the physical address is stored, and setting the source physical address as the destination physical address.

3. The method of claim 2, wherein modifying the address mapping table and the reverse address mapping table further comprises writing a mapping between the destination logical address and the source physical address into the address mapping table.

4. The method of claim 3, modifying the address mapping table and the reverse address mapping table further comprises writing mappings between the subsequent number of data blocks of the destination logical address and the subsequent number of data blocks of the source physical address, respectively, into the address mapping table.

5. The method of claim 1, wherein receiving the non-duplication copy command comprises receiving the non-duplication copy command invoked by an operation system from a software to the solid-state drive.

6. The method of claim 1, further comprising:
when at least one of the logical addresses or one of the physical addresses in the reverse address mapping table is affected by garbage collection and static wear leveling performed in the FTL, updating the address mapping table and the reverse address mapping table based on the affected at least one of the logical addresses or one of the physical addresses.

7. A system for data copying in FTL of a solid-state drive, the system comprising:
a mapping table maintenance unit configured to maintain, in the FTL, i) an address mapping table for mapping logical addresses to physical addresses, (ii) an array or a linked list for at least one destination physical address of the physical addresses that are to be copied, the array or the linked listing recording one or more logical addresses of the logical addresses mapping to the at least one destination physical address, and (iii) a reverse address mapping table for mapping the at least one destination physical address to the one or more logical addresses;
a command receiving unit configured to receive a non-duplication copy command comprising a source logical address, a destination logical address, and a number of data blocks to be copied; and
a modification unit configured to determine a source physical address of the non-duplication copy command to which the source logical address maps based on the address mapping table, and perform the non-duplication copy command by modifying the address mapping table and the reverse address mapping table to map the destination logical address to the source physical address.

8. The system of claim 7, wherein the modification unit is further configured to:
look up the address mapping table in the FTL to determine whether the destination logical address has mapped to one of the destination physical address;
in response to the destination logical address has not mapped to a physical address, set the source physical address as the destination physical address; and
in response to the destination logical address has mapped to a physical address, invalidate a Flash memory page on which the physical address is stored, and set the source physical address as the destination physical address.

9. The system of claim 8, wherein the modification unit is further configured to write a mapping between the destination logical address and the source physical address into the address mapping table.

10. The system of claim 9, wherein the modification unit is further configured to write mappings between the subsequent number of data blocks of the destination logical address and the subsequent number of data blocks of the source physical address, respectively, into the address mapping table.

11. The system of claim 7, wherein command receiving unit configured to receive the non-duplication copy command invoked by an operation system from a software to the solid-state drive.

12. The system of claim 7, wherein the modification unit is further configured to when at least one of the logical addresses or one of the physical addresses in the reverse address mapping table is affected by garbage collection and static wear leveling performed in the FTL, update the address mapping table and the reverse address mapping table based on the affected at least one of the logical addresses or one of the physical addresses.

13. A solid-state drive comprising a FTL, wherein the FTL is configured to execute the following steps:
maintaining, in the FTL, (i) an address mapping table for mapping logical addresses to physical addresses, (ii) an array or a linked list for at least one destination physical address of the physical addresses that are to be copied, the array or the linked listing recording one or more logical addresses of the logical addresses mapping to the at least one destination physical address, and (iii) a reverse address mapping table for mapping the at least one destination physical address to the one or more logical addresses;
receiving a non-duplication copy command by the solid-state drive comprising a source logical address, a destination logical address, and a number of data blocks to be copied;
determining a source physical address to which the source logical address maps based on the address mapping table; and
performing the non-duplication copy command by modifying the address mapping table and the reverse address mapping table to map the destination logical address to the source physical address.

14. The solid-state drive of claim 13, wherein the FTL is configured to execute the following steps:
looking up the address mapping table in the FTL to determine whether the destination logical address has mapped to one of the destination physical address;
in response to the destination logical address has not mapped to a physical address, setting the source physical address as the destination physical address; and
in response to the destination logical address has mapped to a physical address, invalidating a Flash memory page on which the physical address is stored, and setting the source physical address as the destination physical address.

15. The solid-state drive of claim 14, wherein the FTL is configured to execute the following step:
writing a mapping between the destination logical address and the source physical address into the address mapping table.

16. The solid-state drive of claim 15, wherein the FTL is configured to execute the following step:
writing mappings between the subsequent number of data blocks of the destination logical address and the subsequent number of data blocks of the source physical address, respectively, into the address mapping table.

17. The solid-state drive of claim 13, wherein the FTL is configured to execute the following step:
receiving the non-duplication copy command invoked by an operation system from a software to the solid-state drive.

18. The solid-state drive of claim 13, wherein the FTL is configured to execute the following step:
when at least one of the logical addresses or one of the physical addresses in the reverse address mapping table is affected by garbage collection and static wear leveling performed in the FTL, updating the address mapping table and the reverse address mapping table based on the affected at least one of the logical addresses or one of the physical addresses.
